(19) United States
(12) Patent Application Publication
(10) Pub. No.: US 2025/0245545 A1
(43) Pub. Date: Jul. 31, 2025

(54) SYSTEMS AND METHODS FOR DETERMINING USER GUIDANCE BASED ON LONGEVITY

(71) Applicant: Capital One Services, LLC, McLean, VA (US)

(72) Inventors: Joshua EDWARDS, Philadelphia, PA (US); Michael MOSSOBA, Great Falls, VA (US); Tyler MAIMAN, Melville, NY (US)

(73) Assignee: Capital One Services, LLC, McLean, VA (US)

(21) Appl. No.: 18/422,503

(22) Filed: Jan. 25, 2024

(51) Int. Cl. G06N 20/00

(52) U.S. Cl. CPC G06N 20/00

(57) ABSTRACT

A plurality of first item level features may be captured from a plurality of first terminal processes. A first item identifier may be determined and a trigger condition for a criteria associated with the first item identifier may be determined. A request for a user node associated with the first item identifier may be generated in response to the trigger condition. The user node may be captured. The plurality of item level features and the user node may be provided to a node index machine-learning algorithm as training data, the algorithm configured to train a node index machine-learning model configured to generate or update a node index associated with the first item identifier. A plurality of second item level features may be captured from a second terminal process and may be provided to the machine-learning model, receiving an output from the machine-learning model in response.

### TECHNICAL FIELD

Various embodiments of this disclosure relate generally to machine-learning-based techniques for securely determining associations between item level, and, more particularly, to systems and methods for determining user guidance based on longevity.

### BACKGROUND

One method that consumers use to inform their purchasing decisions may be to access reviews of products the consumer is considering for purchase. However, a consumer would likely not have the time or ability to look at each and every review associated with a particular product, nor does the consumer have the ability to ensure the reviews are relevant. It is often the case that consumers, relying on their own knowledge or experience alone, may not have the information or complete information with which to make the best purchasing decisions. Using machine-learning, a large sum of information may be leveraged to help consumers make decisions. Additionally, reviews may be collected based on criteria for longevity associated with a particular product.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for determining user guidance based on longevity.

In one aspect, an exemplary embodiment of a method for determining user guidance based on longevity may include capturing, by one or more processors, a plurality of first item level features from a plurality of first terminal processes. The method may further include determining a first item identifier based on the plurality of first item level features. The method may further include determining a trigger condition for a criteria associated with the first item identifier. The method may further include generating a request for a user node associated with the first item identifier in response to the trigger condition. The method may further include capturing, by the one or more processors, the user node associated with the first item identifier. The method may further include providing, by the one or more processors, the plurality of item level features and the user node to a node index machine-learning algorithm as training data. The node index machine-learning algorithm may be configured to train a node index machine-learning model by modifying one or more of a weight, a layer, or a synapse of the node index machine-learning model, such that the node index machine-learning model may be configured to generate or update a node index associated with the first item identifier. The method may further include capturing a plurality of second item level features from a second terminal process. The plurality of second item level features may correspond to the first item identifier. The method may further include providing the plurality of second item level features to the node index machine-learning model. The method may further include receiving a node index score machine-learning model output in response to providing the plurality of second item level features to the node index machine-learning model.

In another aspect, an exemplary embodiment of using a machine-learning model may include capturing, by one or more processors, a plurality of item level features from a single terminal process. The plurality of item level features may include at least one item identifier. The method may further include providing the plurality of item level features to a machine-learning model trained to generate or update a node index associated with the at least one item identifier. The method may further include receiving, from the machine-learning model, a machine-learning output comprising a decline indication based on the node index. The method may further include issuing, by the one or more processors, a decline code for the single terminal process based on the decline indication.

In a further aspect, an exemplary embodiment of a system for determining user guidance based on longevity may include a memory storing instructions and a processor operatively connected to the memory and configured to execute the instruction to perform operations. The operations may include capturing, by one or more processors, a plurality of first item level features from a plurality of first terminal processes. The operations may further include determining a first item identifier based on the plurality of first item level features. The operations may further include determining a trigger condition for a criteria associated with the first item identifier. The operations may further include generating a request for a user node associated with the first item identifier in response to the trigger condition. The operations may further include capturing, by the one or more processors, the user node associated with the first item identifier. The operations may further include providing, by the one or more processors, the plurality of item level features and the user node to a node index machine-learning algorithm as training data. The node index machine-learning algorithm may be configured to train a node index machine-learning model by modifying one or more of a weight, a layer, or a synapse of the node index machine-learning model, such that the node index machine-learning model may be configured to generate or update a node index associated with the first item identifier. The operations may further include capturing a plurality of second item level features from a second terminal process. The plurality of second item level features may correspond to the first item identifier. The operations may further include providing the plurality of second item level features to the node index machine-learning model. The operations may further include receiving a node index score machine-learning model output in response to providing the plurality of second item level features to the node index machine-learning model.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for using a machine-learning model to determine user guidance based on longevity, according to one or more embodiments.

FIG. 2 depicts a data flow diagram of using a machine-learning model to determine user guidance based on longevity, according to one or more embodiments.

FIG. 3 depicts a flowchart of an exemplary method of using a decision system, according to one or more embodiments.

FIG. 4 depicts a flowchart of another exemplary method of using the decision system, according to one or more embodiments.

FIG. 5 depicts a flow diagram for training a machine-learning model, according to one or more embodiments.

FIG. 6 depicts an example of a computing device, according to one or more embodiments.

### DETAILED DESCRIPTION OF EMBODIMENTS

According to certain aspects of the disclosure, methods and systems are disclosed for determining user guidance based on longevity (e.g., determining a recommended product based upon a node index). Consumers must be able to rely on the relevancy of user reviews to make purchasing decisions (e.g., in addition to the content or rating associated with user reviews). However, conventional techniques may not be suitable. Accordingly, improvements in the technology relating to determining such guidance for a user/consumer are needed.

As will be discussed in more detail below, in various embodiments, systems and methods are described for using machine-learning to determine user guidance based on longevity. By training a machine-learning model, e.g., via supervised or semi-supervised learning, to learn associations between item level features, e.g., data related to purchase transactions, and one or more user nodes, e.g., user reviews the trained machine-learning model may be usable to determine a recommended product for the user, and/or to decline a purchase transaction of a product.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software. As used herein, terms such as “guidance” or the like generally encompass one or more recommendations.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a machine-learning algorithm may be configured to train a machine-learning model by modifying one or more of a weight, a layer, a node, and/or a synapse of the machine-learning model such that the machine-learning model may be configured to generate or update a node index associated with the at least one item identifier

In another exemplary use case, a machine-learning model may be trained to generate or update a node index and/or node index score associated with the at least one item identifier. A machine-learning output of the machine-learning model may include a decline indication based on a node index and/or node index score. A decline code may then be issued for the single terminal process based on the decline indication.

While the examples above involve determining user guidance based on longevity, it should be understood that techniques according to this disclosure may be adapted to any suitable type of determining guidance. It should also be understood that the examples herein are illustrative only. The techniques and technologies of this disclosure may be adapted to any suitable activity.

As used herein, and as discussed in greater detail below, “longevity” may refer to a period of time appropriate to, or associated with, a particular item. For example, a trigger condition machine-learning model may be trained to determine trigger conditions based on an amount of time a given item (e.g., associated with respective item level features) requires use of that item to determine a useful review of the item. For example, the amount of time for a useful review of a mattress may be different than the amount of time for a useful review of a head of lettuce. In such an example, a useful review of a mattress may require a longer amount of time to pass, with use of that mattress, before a useful review can be obtained. By contrast, a review of a head of lettuce would likely become less useful as more time passed (e.g., because of the consumable nature of the head of lettuce). Therefore, longevity, as used herein, may refer to the association of time with each unique item.

Conventionally, a user (e.g., consumer) may need to rely on the user's own purchase history and experience to make purchasing decisions, which may lead to decisions being made on incomplete information about the products purchased. Further, user-submitted reviews on products may not be reliable if the reviews are not collected at times that are relevant to a particular product. Therefore, presented below are also various aspects of machine-learning techniques that may be adapted to determining user guidance and declining a transaction. As will be discussed in more detail below, machine-learning techniques adapted to determining user guidance, may include one or more aspects according to this disclosure, e.g., finding associations between a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

Presented below are also various aspects of techniques that may be adapted to determining user guidance by using a user guidance system. In examples, one or more processors may capture a first set of data from a receipt or point-of-sale transaction, or the like. A name or description, or Universal Product Code (UPC), of at least one item (e.g., item purchased) represented within the data may be determined or extracted from the data. Upon the occurrence of a trigger condition, such as the passage of time unique to the item, a request for a user node may be pushed to a user device by the user guidance system. The user node may therefore be captured and associated with the item, or its identifier, using the user guidance system. In this way, the user nodes captured may be prioritized based on a longevity associated with the item.

The first set of data captured from the point-of-sale transaction, along with the user node, may be provided by one or more processors to a node index machine-learning algorithm as training data; the node index machine-learning algorithm having been configured to train a node index machine-learning model by modifying one or more of a weight, a layer, or a synapse of the node index machine-learning model, such that the node index machine-learning model may be configured to generate or update a node index associated with the item or its identifier.

One or more processors may capture at least one other set of data from another receipt or point-of-sale transaction, or the like. This data, though associated with another user, may correspond to the item or its identifier. The data may also be provided to the node index machine-learning model. A node index score may therefore be output by the machine-learning model in response to the other set of data being provided to the node index machine-learning model.

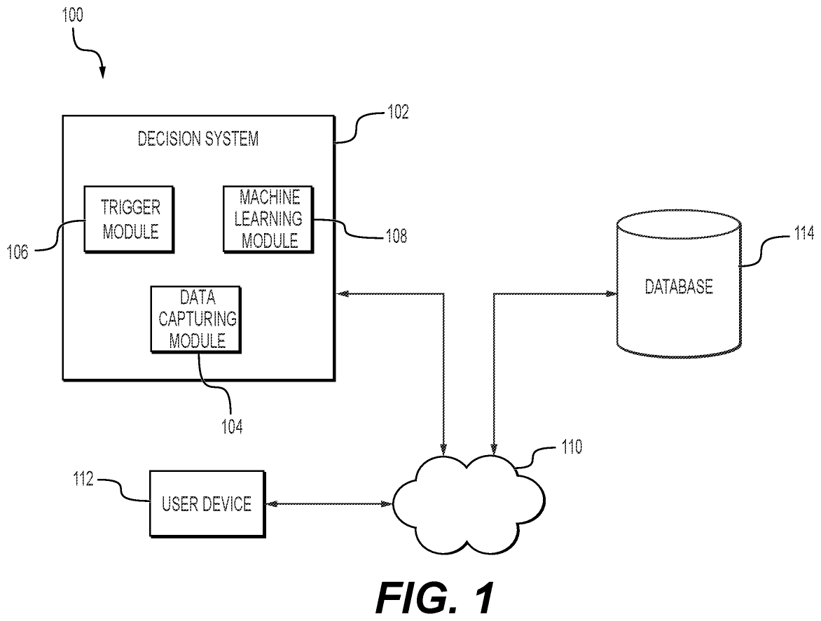

FIG. 1 depicts an exemplary environment 100 that may be utilized with techniques presented herein. One or more user device(s) 112 may communicate across an electronic network 110. As will be discussed in further detail below, one or more decision system(s) 102 may communicate with one or more of the other components of the environment 100 across electronic network 110. The one or more user device(s) 112 may be associated with a user, e.g., a user associated with one or more of generating, training, or tuning a machine-learning model for generating or updating a node index and/or node index score, issuing a decline code, generating, obtaining, uploading, or analyzing item level features, issuing a decline code, and/or updating a node index and/or node index score.

In some embodiments, the components of the environment 100 are associated with a common entity, e.g., a financial institution, transaction processor, merchant, vendor, or the like. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, or use a machine-learning model to generate or update a node index and/or node index score, and/or issue a decline code among other activities.

The user device(s) 112 may be configured to enable a user to access and/or interact with other systems in the environment 100. For example, the user device(s) 112 may be a computer system such as, for example, a desktop computer, a mobile device, a tablet, etc. In some embodiments, the user device(s) 112 may include one or more electronic application(s), e.g., a program, plugin, browser extension, etc., installed on a memory of the user device(s) 112. In some embodiments, the electronic application(s) may be associated with one or more of the other components in the environment 100. For example, the electronic application(s) may include one or more of system control software, system monitoring software, software development tools, etc.

In various embodiments, the environment 100 may include a database 114. The database 114 may include a server system and/or a data storage system such as computer-readable memory such as a hard drive, flash drive, disk, etc. In some embodiments, the database 114 includes and/or interacts with an application programming interface for exchanging data to other systems, e.g., one or more of the other components of the environment. The database 114 may include and/or act as a repository or source for storing one or more item level features, user nodes, or the like. For example, the item level features of each of the terminal processes may be used by decision system(s) 102 to determine that a trigger for a criteria has been satisfied, as discussed in more detail below.

In various embodiments, the electronic network 110 may be a wide area network (“WAN”), a local area network (“LAN”), personal area network (“PAN”), or the like. In some embodiments, electronic network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, the decision system(s) 102 may one or more of (i) generate, store, train, or use a machine-learning model configured to generate or update a user node and issue a decline code. The decision system(s) 102 may include a machine-learning model and/or instructions associated with the machine-learning model, e.g., instructions for generating a machine-learning model, training the machine-learning model, using the machine-learning model etc. The decision system(s) 102 may include instructions for retrieving item-level features, adjusting item-level features, and/or user nodes, a node index e.g., based on the output of the machine-learning model, and/or operating a display of the user device(s) 112 to provide output, e.g., as adjusted based on the machine-learning model. The decision system(s) 102 may include training data, e.g., item-level features, and may include ground truth, e.g., (i) training item-level features and (ii) training user nodes to generate or update a node index or issue a decline code.

As depicted in FIG. 1, decision system(s) 102 may include data capturing module 104. In various embodiments, data capturing module 104 is configured to capture item level features from terminal processes (e.g., capturing transaction data from point-of-sale/point-of-service transactions). In examples, the item level features may include at least one item identifier (e.g., a universal product code “UPC”, item number, or other information that identifies a particular product). In various embodiments, data capturing module 104 may also be configured to capture a user node associated with an item identifier. As used herein, a user node may include a user's review, scoring, and/or feedback related to a particular product (e.g., the particular product identified by the at least one item identifier). The data gathered may then be provided to machine-learning module 108 as input. In various embodiments, machine-learning module 108 may be configured to receive as input the training data for the machine-learning model as described above. Machine-learning module 108 may also be configured to output the trained machine-learning model as will be described in further detail below.

Decision system(s) 102 may also include trigger module 106. In various embodiments, trigger module 106 may be configured to determine a trigger for a criteria associated with an item identifier. Trigger module 106 may be further configured to generate a request for a user node (e.g., user review) associated with the item identifier (e.g., purchased product) in response to the trigger. In various implementations, the trigger may relate to the passage of a predetermined amount of time, and the criteria may represent the passage of a predetermined amount of time as related to a particular purchased product (e.g., item identifier). In one example, a user/consumer may purchase a mattress. The user's review for that mattress may be requested when 3 months has passed, since the time of purchase, because the review is likely to be more relevant after the user has used the mattress for that amount of time. In another example, a user/consumer may purchase a head of lettuce. The user's review for the head of lettuce may be requested up until one week has passed, since the time of purchase, because the lettuce is likely to spoil after that amount of time, rendering a user's review of the lettuce less relevant after that time. In various implementations, trigger module 106 may provide the user node to the machine-learning model or algorithm.

In some embodiments, a system or device other than the decision system(s) 102 is used to generate and/or train the machine-learning model. For example, such a system may include instructions for generating the machine-learning model, the training data and ground truth, and/or instructions for training the machine-learning model. A resulting trained-machine-learning model may then be provided to the decision system(s) 102.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between item level features and one or more user nodes, such that the trained machine-learning model is configured to generate or update a node index and/or node index score or issue a decline code based on the learned associations. As used herein, a node index and/or node index score may include a standardized index based on user nodes (e.g., user reviews) that may include scores, text reviews, image reviews, video reviews, and the like, and/or a composite score based on the node index for a given item. In examples, the user node may be captured via a web browser extension, via a user device, or the like. In examples, the node index score may be a numerical value that represents the various entries of a node index. The node index sore may be a normalized score such that items in different categories can be compared to each other based on their respective node index scores. The node index may be weighted by the trained machine-learning model based on a plurality of third-party user nodes. In examples, the plurality of third-party user nodes may be reviews from other users.

Further, a plurality of unique user data of a unique user may be captured from the user node. In examples, the user node (e.g., the user review), or the means by which the user node is captured, may additionally capture data unique to that user, such as a location of the user, search and/or web browsing history of the user, purchase history of the user, preference data of the user, purchase history of the user, data from related applications (e.g., social media), or the like. In various implementations, the plurality of unique user data may be further provided to the machine-learning model as training data. In examples, the unique user data may further train the machine-learning model to inform the output (e.g., a recommendation or decline indication, or the like).

In various embodiments, the variables of a machine-learning model may be interrelated in any suitable arrangement in order to generate the output. For example, in some embodiments, the machine-learning model may include content-processing architecture that is configured to identify, isolate, and/or extract features, geometry, and or structure in one or more of optical character recognition (OCR) data and/or non-optical in vivo image data. For example, the machine-learning model may include one or more convolutional neural network (“CNN”) configured to identify features in item level reports (e.g., transaction receipts), and may include further architecture, e.g., a connected layer, neural network, etc., configured to determine a relationship between the identified features in order to generate or update a node index and/or node index score.

In some instances, different samples of training data and/or input data may not be independent. For example, samples of training data may include item level features captured from purchase transaction receipts, electronic transaction data, user nodes from a variety of platforms, and the like. Thus, in some embodiments, the machine-learning model may be configured to account for and/or determine relationships between multiple samples, at times from multiple sources.

For example, in some embodiments, the machine-learning model of the decision system 102 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive a sequence of item level features and user nodes as input, and generate or update a node index as output.

Although depicted as separate components in FIG. 1, it should be understood that a component or portion of a component in the environment 100 may, in some embodiments, be integrated with or incorporated into one or more other components. For example, a display may be integrated into the user device 112 or the like. In another example, the decision system 102 may be integrated in a data storage system. The data storage system may be configured to communicate and/or receive/send data across electronic network 110 to other components of environment 100. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized are discussed in further detail in the methods below. In the following methods, various acts may be described as performed or executed by a component from FIG. 1, such as decision system 102, the user device 112, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

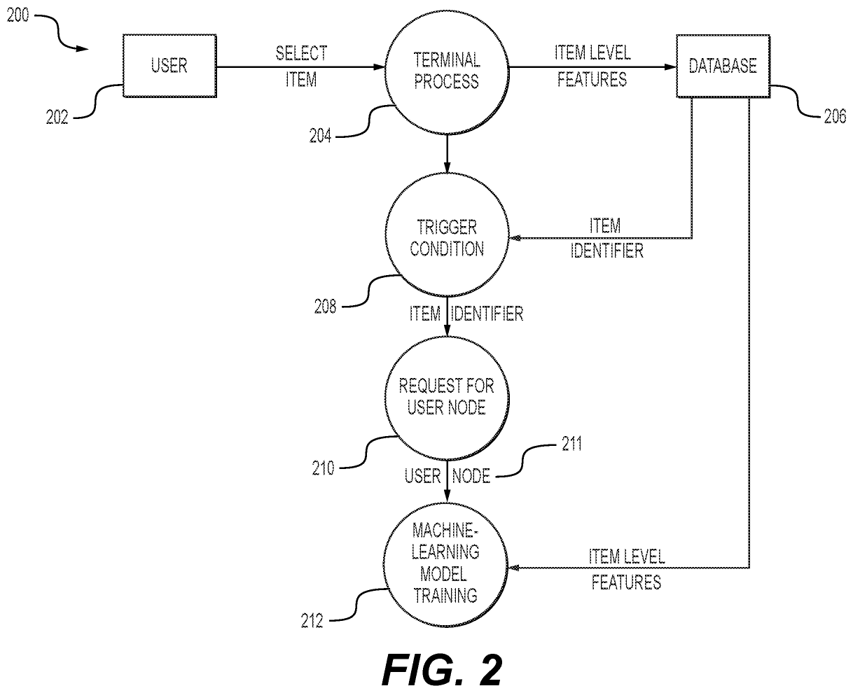

FIG. 2 illustrates a data flow diagram 200 of using a machine-learning model to determine user guidance based on longevity. As illustrated, and in various embodiments, a user 202, selects an item (e.g., a product to purchase). The purchase of the item is transacted by a terminal process 204 (e.g., a point-of-sale transaction). In various embodiments, item level features are captured from the terminal process and may be stored in database 206. The item level features may be captured using optical character recognition (OCR). In examples, the item level features captured may include items purchased (e.g., identified by a UPC, item number, or other unique descriptor), a category of each item purchases, a date/time of the terminal process, a location of the terminal process, a merchant or vendor associated with the terminal process, and the like. As illustrated, an item identifier (e.g., identifier of a purchased item) may be selected from among the item level features captured. In examples, the plurality of item level features from the single terminal process may be captured using an application programming interface (API).

The item level features may be captured based on an analysis of transaction data associated with the transaction. For example, a user may initiate terminal process 204 by selecting an item (e.g., a product, a service, a subscription, etc.) and/or completing a respective transaction. Transaction data associated with the transaction may be generated and item level features may be extracted from the transaction data. Alternatively, or in addition, a transaction confirmation may be generated based on the transaction. The transaction confirmation or transaction data may be input into at data capturing module 104. Data capturing module 104 may extract the item level features from the transaction confirmation or transaction data.

According to an embodiment, a transaction confirmation or transaction data may be provided as inputs into a features machine-learning model. The features machine-learning model may be trained by modifying one or more weights, layers, nodes, synapses, etc., based on training data that may include historical transaction confirmations, historical transaction data, simulated transaction confirmation, simulated transaction data, and/or the like. The training data may be tagged or untagged (e.g., for supervised, semi-supervised, or unsupervised training). The features machine-learning model may generate an output including the item level features determined based on the input transaction confirmation or transaction data. Alternatively, or in addition, the features machine-learning model may output a feature confidence score, where the feature confidence score indicates a level of confidence that an output item feature is the item feature associated with the transaction confirmation or transaction data. Item features may be determined based on the respective feature confidence score meeting a feature confidence score threshold.

In various embodiments, a trigger condition 208 for a criteria associated with the at least one item identifier may be determined. As in the example discussed above, for an item identifier that identifies a mattress, the trigger condition may be determined to be 3 months. Trigger condition 208 may be output by a trigger condition machine-learning model based on an input including the item level features. The trigger condition machine-learning model may be trained by modifying one or more weights, layers, nodes, synapses, etc., based on training data that may include historical item level features, historical trigger conditions, simulated item level features, simulated trigger conditions, and/or the like. The training data may be tagged or untagged (e.g., for supervised, semi-supervised, or unsupervised training). The trigger condition machine-learning model may generate an output including the trigger condition(s) determined based on the input item level features. For example, the trigger condition machine-learning model may be trained to determine trigger conditions based on an amount of time a given item (e.g., associated with respective item level features) requires use to determine a useful review of the item. As discussed in the examples above, the amount of time for a useful review of a mattress may be different than the amount of time for a useful review of a head of lettuce. The trigger condition machine-learning model may output trigger conditions based on an amount of time for useful use of an item, based on an indication that an item has been used by a user (e.g., based on a user account, based on a registration of an item, based on data associated with use of the item, etc.), level of use of product (e.g., based on a user account, based on a registration of an item, based on data associated with use of the item, etc.), and/or the like.

In response to the trigger condition (e.g., the passage of the determined period of time), a request for a user node 210 is generated that is associated with the item identifier that was captured from the terminal process 204. In various embodiments, the user node represents a review (e.g., score) given by the user that relates to their level of satisfaction of the product identified by the item identifier. The request for user node 210 may be triggered upon meeting the trigger condition (e.g., expiration of applicable time, use of product, level of use of the product, etc.).

As illustrated in FIG. 2, the user node may be received (e.g., via user device 112) and may be passed to the machine-learning model 212, along with the item level features stored in database 206, as input or training data. Machine-learning model 212 may include the one or more machine-learning models discussed herein including a features machine-learning model, a trigger condition machine-learning model, a node index machine-learning model, etc. In various implementations, a node index machine-learning model may be trained by modifying one or more of a weight, a layer or a synapse of the node index machine-learning model such that the node index machine-learning model may be configured to generate or update a node index associated with the item identifier. In examples, the node index may represent a collection or collation of multiple user nodes. In one example, the node index may represent an average of approximately 1,000 user reviews (e.g., user nodes) for a mattress. In various embodiments, the node index machine-learning model may be configured to output a decline indication based upon the node index. In examples, the decline indication may prevent the purchase of a particular product based upon the node index associated with that product.

As discussed above, a node index or updated node index may be generated by a node index machine-learning model based on an input including item level features (e.g., as output by the features machine-learning model), and user node 211. The node index machine-learning model may be trained by modifying one or more weights, layers, nodes, synapses, etc., based on training data that may include historical item level features, historical node user nodes, historical node indexes, simulated item level features, simulated node user nodes, simulated node indexes, and/or the like. The training data may be tagged or untagged (e.g., for supervised, semi-supervised, or unsupervised training). The node index machine-learning model may generate or update the node index based on the input item level features and user node 211. For example, the node index machine-learning model may be trained to generate or update a node index based on correlating the input of user node 211 with one or more user nodes (e.g., including user node 211) such that the node index for a given item associated with the item level features includes relevant user feedback (e.g., time relevant, use relevant, etc., as discussed herein) generated based on user nodes received based on meeting respective trigger conditions, as discussed herein. The node index machine-learning model may be configured to generate or update a node index for a given item based on the item level features such that even if a given feature of an item (e.g., a UPC, item number, item description, or other information that identifies a particular product) defers across different instances (e.g., transactions) of the item, the node index machine-learning model is configured to relate the user nodes associated with that item despite the differences. For example, a mattress may include a first item description (e.g., “air mattress”) at a first merchant and a second item description (e.g., “floating mattress”) at a second merchant. The node index machine-learning model may be configured to associate the mattress as one item, despite the deferring item descriptions across merchants. The node index machine-learning model may associate an item with deferring item level descriptions based on overlapping or correlated other item level features, based on supervised, unsurprised, or semi-supervised training, and/or the like.

According to an embodiment, as shown in FIG. 2, a node index machine-learning model may be trained or re-trained based on a plurality of item level features and one or more user nodes, as disused herein. A trained node index machine-learning model may receive, as an input item level features of an item to be purchased by a user. The trained node index machine-learning model may output a recommendation, a decline indication, a notification, an alert, or may take an action based on the node index associated with the input item level features. For example, the node index machine-learning model may determine a node index score associated with the input item level features. The node index score may be output based on training the node index machine-learning model based on one or more user nodes (e.g., user reviews, user review scores, etc.). The node index score may be used to output a recommendation, a decline indication, a notification, an alert, or may take an action based on the node index associated with the input item level features (e.g., if the node index score meets one or more node index thresholds for triggering a recommendation, a decline indication, a notification, an alert, or an action).

In examples, a recommendation may include a recommendation to a user to not purchase an item based upon the node index score. In an example, if a user selects a set of preferences that indicate that the user does not wish to purchase any item with a rating of less than 3 stars, then a push notification or other electronic message may be sent to the user to flag, for the user, that the rating of the item does not match the user's preferences. The recommendation may take a variety of forms. In examples, the recommendation may be a push notification sent to the user's device. In still other examples, the recommendation may be an alert (e.g., a text message, email, or the like). Further, a decline indication may be issued based on the node index score or a user threshold (e.g., set by user preferences). In one particular example, if a mattress has a rating of 2 stars and the user attempting to purchase the mattress has indicated that they do not wish to purchase any mattress that has a rating of less than 3 stars (e.g., a user threshold), then the issuer of the credit card being used for the purchase may decline the transaction. In such an example, a push notification may be sent to the user's device to explain why the purchase was declined and may also allow to user to override the purchase decline and proceed with the transaction. In examples, the decline code issued in such a decline indication may be unique to the particular circumstance of declining the purchase based on the node index score.

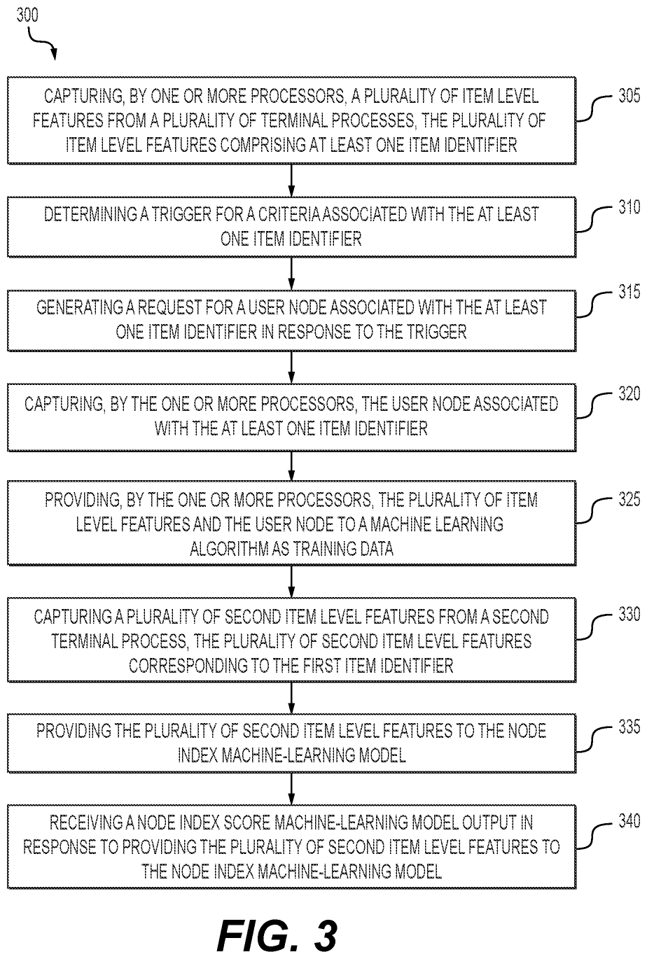

FIG. 3 illustrates an exemplary process 300 for using the decision system, such as in the various examples discussed herein. At step 305, a plurality of item level features from a plurality of terminal processes are captured in accordance with the techniques disclosed herein. In examples, one or more processors of any of the components described herein (e.g., in reference to FIG. 1 or 2) may be used to capture the item level features. The plurality of item level features may include at least one item identifier. In one example, a user may purchase a mattress and transaction data from the purchase may be captured. An item identifier, such as an item number associated with the mattress may be included in the transaction data. In various embodiments, the item level features may be captured by a decision system, such as decision system 102, as depicted in FIG. 1, such as by data capturing module 104 of decision system 102. In examples, the item level features may be captured by decision system 102 from a point-of-sale device, from transaction data captured by a credit card processor, or the like.

At step 310, a trigger condition for a criteria associated with the at least one item identifier is determined. As described above, the trigger condition may represent a predetermined period of time that is appropriate for a given item identifier, may represent a level of use for the given item, or etc. In one particular example, if the user has purchased a mattress, the trigger may be determined to be 3 months. In various embodiments, the trigger may be determined by decision system 102, as depicted in FIG. 1, such as by trigger module 106 of decision system 102 (e.g., via a trigger condition machine-learning model). At step 315, a request for a user node associated with the at least one item identifier is generated in response to the trigger condition being met. In examples, the request for a user node may be a push notification transmitted to a user device, such as user device 112 depicted in FIG. 1. The request may be a request for a user to review and/or score the purchased product. In one particular example, if the user has purchased a mattress, the request to the user to review or score the mattress may be generated in response to the trigger (e.g., after 3 months has passed since the purchase date). In various embodiments, the request for a user node may be generated using decision system 102, as depicted in FIG. 1, such as by trigger module 106 of decision system 102.

At step 320, the user node associated with the at least one item identifier is captured. In various embodiments, the user node may be captured by a decision system, such as decision system 102, as depicted in FIG. 1, such as by data capturing module 104 of decision system 102. In examples, the user node may be captured from a user device, such as user device 112 depicted in FIG. 1. As discussed above, the user node may represent a user's score or review of a purchased item. At step 325, the plurality of item level features and the user node is provided to a node index machine-learning algorithm as training data. The machine-learning algorithm may be configured to train a node index machine-learning model by modifying one or more of a weight, a layer, or a synapse of the machine-learning model such that the machine-learning model may be configured to generate or update a node index associated with the at least one item identifier. In various embodiments, the item level features and the user node may be provided to decision system 102, as depicted in FIG. 1, such as to machine-learning module 108. As discussed herein, the trained node index machine-learning model may receive item level data for an item to be purchased by a user (e.g., at a check-out page, based on an add-to-cart action, etc.) The trained node index machine-learning model may output a node score and/or output a recommendation, a decline indication, a notification, an alert, or may take an action based on the node index or node score associated with an item associated with the input item level features.

At step 330, a plurality of second item level features from a second terminal process may be captured. The second terminal process may be a sale or transaction made by a third party (e.g., another individual). The plurality of second item level features may correspond to the first item identifier. In examples, one or more other individuals may purchase the same model of mattress as a first user. At step 335, the plurality of second item level features may be provided to the node index machine-learning model. At step 340, a node index score machine-learning model output may be received in response to providing the plurality of second item level features to the node index machine-learning model. In examples, reviews from other individuals may also be weighted with the user node to inform the node index score machine-learning model output.

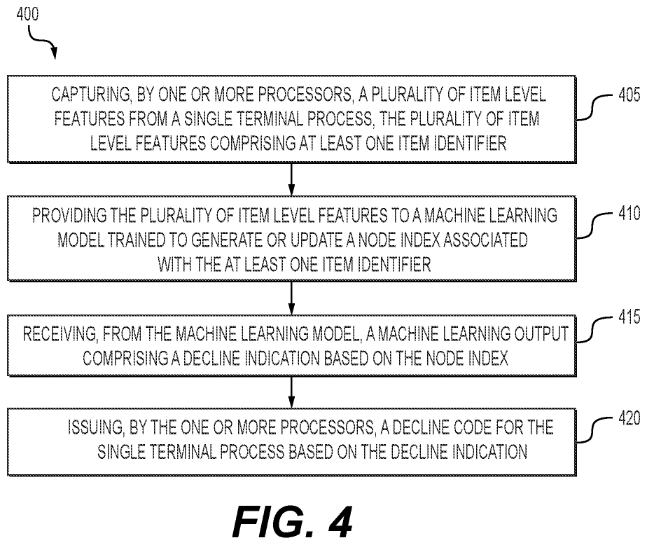

FIG. 4 illustrates another exemplary process 400 for using the decision system, e.g., by utilizing a trained machine-learning model such as a machine-learning model trained according to one or more embodiments discussed above, such as those discussed with respect to FIG. 1. At step 405, a plurality of item level features is captured from a single terminal process. The plurality of item level features may include at least one item identifier. In various embodiments, the item level features may be captured by a decision system, such as decision system 102, as depicted in FIG. 1, such as by data capturing module 104 of decision system 102. In examples, the item level features may be captured by decision system 102 from a point-of-sale device, from transaction data captured by a credit card processor, or the like. At step 410, the plurality of item level features is provided to a machine-learning model (e.g., node index machine-learning model). The machine-learning model may be trained to generate or update a node index associated with the at least one item identifier, as described above.

At step 415, a machine-learning output is received from the machine-learning model. The output may include a node index score and/or a decline indication based on the node index. In examples, the decline indication may be a decline code, such as those issued for an attempted credit card transaction. In one particular example, if the node index score falls below a certain threshold (e.g., the review scores are low), the purchase of particular item may be blocked. At step 420, a decline code is issued for the single terminal process based upon the decline indication.

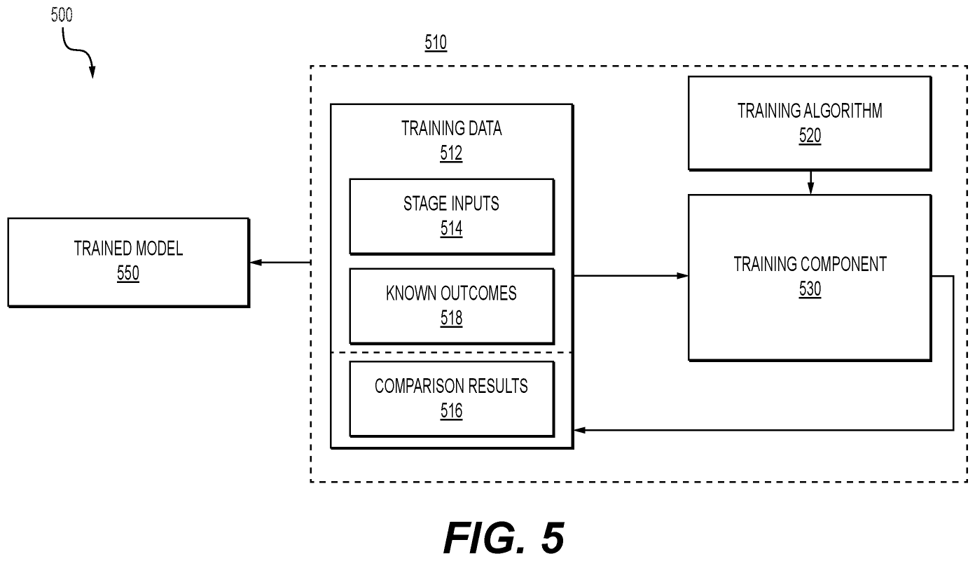

As disclosed herein, one or more implementations disclosed herein may be applied by using a machine-learning model. A machine-learning model as disclosed herein may be trained using one or more components or steps of FIGS. 1-4. As shown in flow diagram 500 of FIG. 5, training data 512 may include one or more of stage inputs 514 and known outcomes 518 related to a machine-learning model to be trained. The stage inputs 514 may be from any applicable source including a component or set shown in the figures provided herein. The known outcomes 518 may be included for machine-learning models generated based on supervised or semi-supervised training. An unsupervised machine-learning model might not be trained using known outcomes 518. Known outcomes 518 may include known or desired outputs for future inputs similar to or in the same category as stage inputs 514 that do not have corresponding known outputs.

The training data 512 and a training algorithm 520 may be provided to a training component 530 that may apply the training data 512 to the training algorithm 520 to generate a trained machine-learning model 550. According to an implementation, the training component 530 may be provided comparison results 516 that compare a previous output of the corresponding machine-learning model to apply the previous result to re-train the machine-learning model. The comparison results 516 may be used by the training component 530 to update the corresponding machine-learning model. The training algorithm 520 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 510 may be a trained machine-learning model 550.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

It should be understood that embodiments in this disclosure are exemplary only, and that other embodiments may include various combinations of features from other embodiments, as well as additional or fewer features. For example, while some of the embodiments above pertain to multipartite relay, any suitable activity may be used.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

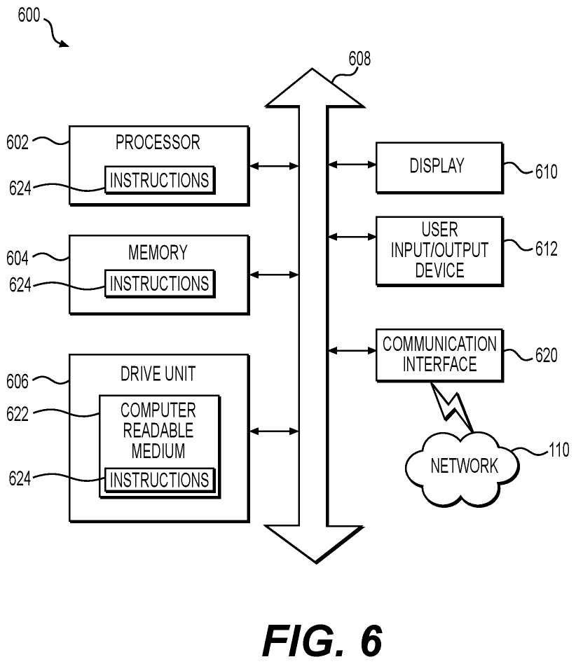

FIG. 6 is a simplified functional block diagram of a computer 600 that may be configured as a device for executing the methods disclosed here, according to exemplary embodiments of the present disclosure. For example, the computer 600 may be configured as a system according to exemplary embodiments of this disclosure. In various embodiments, any of the systems herein may be a computer 600 including, for example, a data communication interface 620 for packet data communication. The computer 600 also may include a central processing unit (“CPU”) 602, in the form of one or more processors, for executing program instructions. The computer 600 may include an internal communication bus 608, and a storage unit 606 (such as ROM, HDD, SDD, etc.) that may store data on a computer readable medium 622, although the computer 600 may receive programming and data via network communications. The computer 600 may also have a memory 604 (such as RAM) storing instructions 624 for executing techniques presented herein, although the instructions 624 may be stored temporarily or permanently within other modules of computer 600 (e.g., processor 602 and/or computer readable medium 622). The computer 600 also may include input and output ports 612 and/or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method comprising:
capturing, by one or more processors, a plurality of first item level features from a plurality of first terminal processes;
determining a first item identifier based on the plurality of first item level features;
determining a trigger condition for a criteria associated with the first item identifier;
generating a request for a user node associated with the first item identifier in response to the trigger condition;
capturing, by the one or more processors, the user node associated with the first item identifier;
providing, by the one or more processors, the plurality of item level features and the user node to a node index machine-learning algorithm as training data, wherein the node index machine-learning algorithm is configured to train a node index machine-learning model by modifying one or more of a weight, a layer, or a synapse of the node index machine-learning model such that the node index machine-learning model is configured to generate or update a node index associated with the first item identifier;
capturing a plurality of second item level features from a second terminal process, the plurality of second item level features corresponding to the first item identifier;
providing the plurality of second item level features to the node index machine-learning model; and
receiving a node index score machine-learning model output in response to providing the plurality of second item level features to the node index machine-learning model.

2. The computer-implemented method of claim 1, wherein the node index machine-learning output comprises one or more of a decline indication, wherein the decline indication comprises one or more of a recommendation, notification, or alert.

3. The computer-implemented method of claim 1, wherein the node index is weighted by the machine-learning model based on a plurality of third-party user nodes.

4. The computer-implemented method of claim 1, wherein the criteria comprises at least one of an a time threshold or a level of use threshold.

5. The computer-implemented method of claim 1, wherein the plurality of item level features from the plurality of terminal processes is captured using optical character recognition (OCR) on a plurality of point-of-service terminal process records.

6. The computer-implemented method of claim 1, wherein the plurality of item level features from the plurality of terminal processes is captured from an electronic transmission of a point-of-service terminal process.

7. The computer-implemented method of claim 1, wherein the user node is captured via a web browser extension.

8. The computer-implemented method of claim 1, wherein the request for a user node associated with the first item identifier in response to the trigger condition comprises a push notification transmitted by a user device.

9. The computer-implemented method of claim 1, wherein a plurality of unique user data of a unique user is captured from the user node.

10. The computer-implemented method of claim 9, wherein the plurality of unique user data is further provided to the machine-learning model as training data.

11. A computer-implemented method for using a machine-learning model, the method comprising:
capturing, by one or more processors, a plurality of item level features from a single terminal process;
determining at least one item identifier based on the plurality of item level features;
providing the plurality of item level features to a machine-learning model trained to generate or update a node index associated with the at least one item identifier;
receiving, from the machine-learning model, a machine-learning output comprising a decline indication based on a the node index; and
issuing, by the one or more processors, a decline code for the single terminal process based on the decline indication.

12. The computer-implemented method of claim 11, wherein the decline indication is further based on a user threshold.

13. The computer-implemented method of claim 11, further comprising outputting, by a user device, a notification based on the decline indication.

14. The computer-implemented method of claim 11, wherein the plurality of item level features from the single terminal process is captured using an application programming interface (API).

15. The computer-implemented method of claim 11, wherein the plurality of item level features from the single terminal processes is captured from an electronic transmission of the single terminal process.

16. A system for training a machine-learning model, the system comprising:
a memory storing instructions; and
a processor operatively connected to the memory and configured to execute the instructions to perform operations including:
capturing, by one or more processors, a plurality of first item level features from a plurality of first terminal processes;
determining a first item identifier based on the plurality of first item level features;
determining a trigger condition for a criteria associated with the first item identifier;
generating a request for a user node associated with the first item identifier in response to the trigger condition;
capturing, by the one or more processors, the user node associated with the first item identifier;
providing, by the one or more processors, the plurality of item level features and the user node to a node index machine-learning algorithm as training data, wherein the node index machine-learning algorithm is configured to train a node index machine-learning model by modifying one or more of a weight, a layer, or a synapse of the node index machine-learning model such that the node index machine-learning model is configured to generate or update a node index associated with the first item identifier;
capturing a plurality of second item level features from a second terminal process, the plurality of second item level features corresponding to the first item identifier;
providing the plurality of second item level features to the node index machine-learning model; and
receiving a node index score machine-learning model output in response to providing the plurality of second item level features to the node index machine-learning model.

17. The system of claim 16, wherein an output of the machine-learning model comprises a decline indication based on the user node and user historical terminal processes.

18. The system of claim 16, wherein the node index is weighted by the machine-learning model based on a plurality of third-party user nodes.

19. The system of claim 16, wherein the criteria comprises at least one of an item category or a time threshold.

20. The system of claim 16, wherein the request for a user node associated with the first item identifier in response to the trigger comprises a push notification transmitted by a user device.
